(19) United States
(12) Patent Application Publication
(10) Pub. No.: US 2008/0116782 A1
(43) Pub. Date: May 22, 2008

(54) LIGHT EMISSION DEVICE AND DISPLAY DEVICE

(76) Inventors: Byoung-Kuk Kim, Yongin-si (KR); Jin-Ho Lee, Yongin-si (KR); Hun-Soo Kim, Yongin-si (KR)

Correspondence Address: CHRISTIE, PARKER & HALE, LLP, PO BOX 7068, PASADENA, CA, 91109-7068, US

(21) Appl. No.: 11/734,240

(22) Filed: Apr. 11, 2007

(30) Foreign Application Priority Data
Nov. 20, 2006 (KR) 10-2006-0114614

(51) Int. Cl. H01J 63/04

(52) U.S. Cl. 313/496

(57) ABSTRACT

A light emission device and display device utilizing the light emission device are provided. The light emission device includes first and second substrates facing each other. Cathode electrodes are arranged on an inner surface of the first substrate. Gate electrodes are arranged above and crossing the cathode electrodes. The gate electrodes have a plurality of openings at crossing regions of the gate electrodes and the cathode electrodes. Electron emission regions are formed on the cathode electrodes in the plurality of openings. A light emission unit is provided on an inner surface of the second substrate. At least one of the electron emission regions is located off of a center of a corresponding one of the plurality of openings.

### CROSS-REFERENCE TO RELATED APPLICATION

This application claims priority to and the benefit of Korean Patent Application No. 10-2006-0114614 filed on Nov. 20, 2006 in the Korean Intellectual Property Office, the entire content of which is incorporated herein by reference.

### BACKGROUND OF THE INVENTION

1. Field of the Invention

The present invention relates to a light emission device and a display device, and more particularly, to a light emission device with enhanced light emission uniformity in an active area, and a display device using the light emission device as a light source.

2. Description of the Related Art

A display device having a passive-type display panel, such as a liquid crystal display panel, needs a light source for emitting light toward the display panel. Cold cathode fluorescent lamp (CCFL) type and a light emitting diode (LED) type light emission devices are generally used as the light source of the display device.

Because the CCFL and LED type light emission devices use a linear light source and a point light source respectively, the light emission devices include a plurality of optical members for uniformly diffusing the light toward the display panel. However, as light passes through the optical members, much light is lost. Therefore, the CCFL and LED type light emission devices have relatively high power consumption for emitting high luminance light, and are difficult to be made in a large size due to structural limitations.

In recent years, a light emission device that can emit visible light by exciting a phosphor layer using electrons emitted from an electron emission region has been developed to replace the CCFL and LED type light emission devices. The light emission device includes a front substrate having an electron emission region and a driving electrode, and a second substrate having a phosphor layer and an anode electrode.

### SUMMARY OF THE INVENTION

The present invention provides a light emission device and a display device using the light emission device as a light source, in which the light emission device can realize a high luminance with less power consumption, emit a uniform intensity of the light throughout an overall active area, and enhance dynamic contrast of the screen.

In an exemplary embodiment of the present invention, a light emission device includes first and second substrates facing each other. Cathode electrodes are arranged on an inner surface of the first substrate. Gate electrodes are arranged above and crossing the cathode electrodes. The gate electrodes have a plurality of openings at crossing regions of the gate electrodes and the cathode electrodes. Electron emission regions are formed on the cathode electrodes in the plurality of openings. A light emission unit is provided on an inner surface of the second substrate. At least one of the electron emission regions is located off of a center of a corresponding one of the plurality of openings.

In an exemplary embodiment of the present invention, the electron emission regions include first electron emission regions arranged along a periphery of respective crossing regions and second electron emission regions surrounded by the first electron emission regions. Each of the first electron emission regions is located off of a center of a corresponding one of the plurality of openings.

In an exemplary embodiment of the present invention, each of the first electron emission regions is located toward a center of a respective crossing region. The distances of each of the first electron emission regions from a center of a corresponding one of the plurality of openings may be substantially equal to each other. On the other hand, each of the second electron emission regions may have a center aligned with a center of a corresponding opening.

The light emission unit may include a phosphor layer provided on an inner surface of the second substrate and an anode electrode formed on one surface of the phosphor layer. A distance between the first and second substrates may be in a range of about 5 mm˜20 mm and the anode electrode may be applied with an anode voltage in a range of about 10 kV˜15 kV.

In another exemplary embodiment of the present invention, a display device includes a display panel for displaying an image and a light emission device for emitting light toward the display panel. The light emission device includes first and second substrates facing each other. Cathode electrodes are arranged on an inner surface of the first substrate. Gate electrodes are arranged above and crossing the cathode electrodes. The gate electrodes have a plurality of openings at crossing region of the gate and cathode electrodes. Electron emission regions are formed on the cathode electrodes in the plurality of openings. A light emission unit is provided on an inner surface of the second substrate. At least one of the electron emission regions is located off of a center of a corresponding one of the plurality of openings.

In an exemplary embodiment of the present invention, the display panel includes first pixels and the light emission device includes second pixels. The number of the second pixels may be less than the number of the first pixels. In addition, light emission intensities of the second pixels may be independently controlled. Furthermore, the display panel may be a liquid crystal display panel.

In an exemplary embodiment of the present invention, a method of improving electron beam diffusion uniformity along a periphery of a crossing region of gate electrodes and cathode electrodes is provided in which the gate electrodes have openings in the crossing region. The method includes forming electron emission regions in the openings on the cathode electrodes, and locating at least one of the electron emission regions off of a center of corresponding openings.

In an exemplary embodiment of the present invention, the openings include periphery openings located along a periphery of said crossing region and non-periphery openings located within the periphery of said crossing region, and the method further includes locating the electron emission regions formed in periphery openings off of a center of corresponding periphery openings.

In an exemplary embodiment of the present invention, the method further includes locating the electron emission regions formed in periphery openings towards a center of said crossing region.

In an exemplary embodiment of the present invention, the method further includes locating each of the electron emission regions formed in periphery openings a substantially equal distance from a center of corresponding periphery openings.

In an exemplary embodiment of the present invention, the method further includes locating the electron emission regions formed in non-periphery openings at a center of corresponding non-periphery openings.

In an exemplary embodiment of the present invention, the periphery openings include side periphery openings and corner periphery openings, and the method further includes locating each of the electron emission regions formed in side periphery openings a substantially equal distance from adjacent electron emission regions formed in non-periphery openings, and locating each of the electron emission regions formed in corner periphery openings a substantially equal distance from adjacent electron emission regions formed in non-periphery openings.

### BRIEF DESCRIPTION OF THE DRAWINGS

FIG. 1 is a partial cut-away perspective view of a light emission device according to an exemplary embodiment of the present invention.

FIG. 2 is a partial sectional view of the light emission device of FIG. 1.

FIG. 3 is a partial top view of an arrangement of openings and electron emission regions positioned at an intersection region of a cathode and a gate electrode of FIG. 1.

FIG. 4A and FIG. 4B are partial sectional views illustrating an electron emission region arranged in a left line with reference to FIG. 3.

FIG. 5A and FIG. 5B are partial sectional views illustrating an electron emission region arranged in a right line with reference to FIG. 3.

FIG. 6 is an exploded perspective view of a display device according to an exemplary embodiment of the present invention.

### DETAILED DESCRIPTION

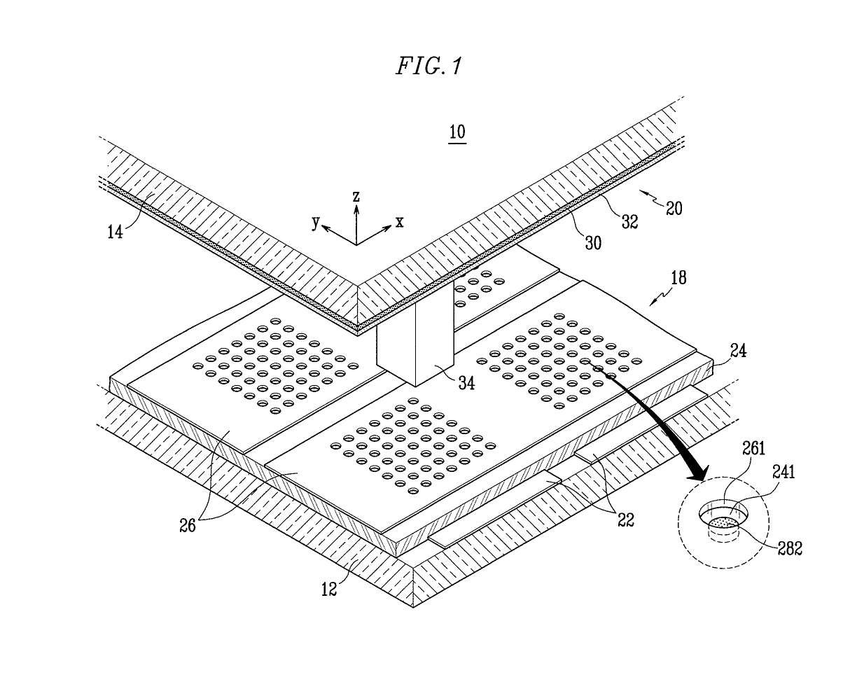

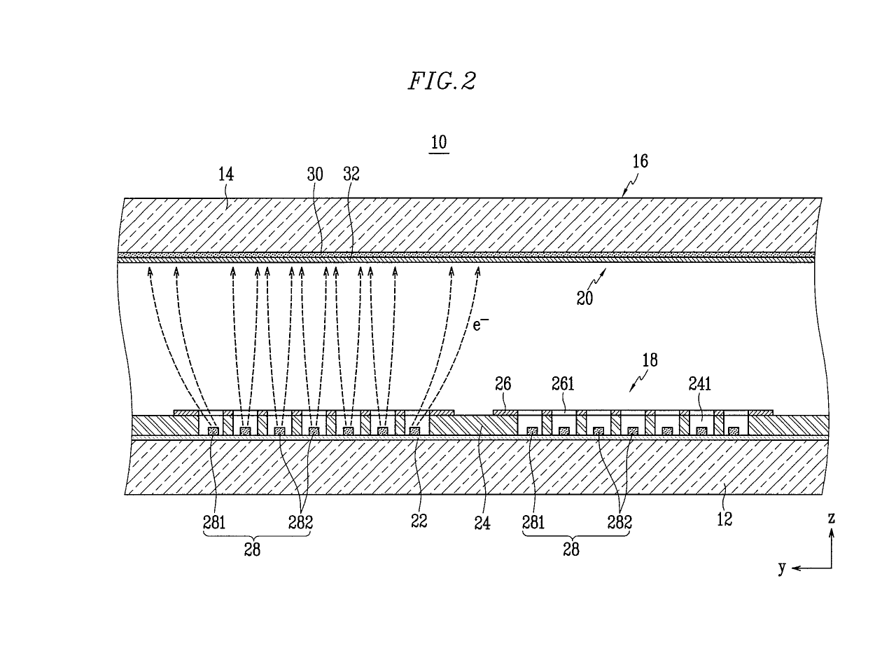

Referring to FIG. 1 and FIG. 2, a light emission device 10 of an exemplary embodiment includes first and second substrates 12, 14 facing each other in parallel at a predetermined interval. A sealing member (not shown) is provided between the first and second substrates 12, 14 to seal them together and thus form a vacuum vessel 16. The interior of the vacuum vessel 16 is kept to a degree of vacuum of about 10⁻⁶ Torr.

Inside the sealing member, the first and second substrates 12, 14 may be divided into an active area substantially emitting visible light and an inactive area surrounding the active area. An electron emission unit 18 for emitting electrons is provided on an inner surface of the first substrate 12 at the active area and a light emission unit 20 for emitting visible light is provided on an inner surface of the second substrate 14 at the active area.

The electron emission unit 18 includes cathode electrodes 22 arranged in a stripe pattern extending in a direction (y-axis of FIG. 1) and gate electrodes 26 arranged in a stripe pattern extending in a direction (x-axis of FIG. 1) intersecting the cathode electrodes 22. An insulating layer 24 is interposed between the cathode electrodes 22 and the gate electrodes 26.

Openings 241 and openings 261 are respectively formed in the insulating layer 24 and the gate electrodes 26 to partly expose a surface of the cathode electrodes 22. Electron emission regions 28 are formed on the cathode electrodes 22 in the openings 241 of the insulating layer 24.

One of the cathode and gate electrodes 22, 26, e.g., the gate electrode 26 extending in a row direction of the light emission device 10, functions as a scan electrode by receiving a scan drive voltage, and the other, e.g., the cathode electrode 22 extending in a column direction of the light emission device 10, functions as a data electrode by receiving a data drive voltage.

The electron emission regions 28 are formed of a material emitting electrons when an electric field is applied thereto under a vacuum atmosphere, such as a carbon-based material or a nanometer-sized material. For example, the electron emission regions 28 can be formed of carbon nanotubes, graphite, graphite nanofibers, diamonds, diamond-like carbon, fullerene C₆₀, silicon nanowires or a combination thereof. The electron emission regions 28 may be formed through a screen-printing process, a direct growth process, or chemical deposition.

Each intersection/crossing region of the cathode and gate electrodes 22, 26 may correspond to one pixel region of the light emission device 10 or two or more intersection/crossing regions of the cathode and gate electrodes 22, 26 may correspond to one pixel region of the light emission device 10. In the latter case, two or more cathode electrodes 22 and/or two or more gate electrodes 26 that are placed at a common pixel region are electrically connected to each other to receive a common driving voltage.

The light emission unit 20 includes a phosphor layer 30 and an anode electrode 32 formed on a surface of the phosphor layer 30. The phosphor layer 30 may be formed of a mixture of red, green and blue phosphors, which can emit white light. The phosphor layer 30 may be formed on the entire active area of the second substrate 14.

The anode electrode 32 may be formed of a metal layer such as an aluminum (Al) layer covering the phosphor layer 30. The anode electrode 32 is an acceleration electrode that receives a high voltage to maintain the phosphor layer 30 at a high electric potential state. The anode electrode 32 functions to enhance the luminance of the active area by reflecting the visible light from the phosphor layer 30 toward the second substrate 14.

Disposed between the first and second substrates 12, 14 are spacers 34 that are able to withstand a compression force applied to the vacuum vessel 16 and to uniformly maintain a gap between the substrates 12, 14. In FIG. 1, a rectangular pillar type spacer 34 is exemplarily illustrated.

The above-described light emission device 10 forms a plurality of pixels by the combination of the cathode and gate electrodes 22, 26 and is driven by applying external driving voltages to the cathode electrodes 22 and the gate electrodes 26 and by applying a positive direction current voltage (anode voltage) of several thousand volts to the anode electrode 32.

Electric fields are formed around the electron emission regions 28 at the pixels where the voltage difference between the cathode and gate electrodes 22, 26 is equal to or greater than the threshold value, and thus electrons are emitted from the electron emission regions 28. The emitted electrons collide with a corresponding portion of the phosphor layer 30 of the relevant pixels by being attracted by the anode voltage applied to the anode electrode 32, thereby exciting the phosphor layer 30. A light emission intensity of the phosphor layer 30 of each pixel corresponds to a light emission amount of the corresponding pixel.

The first and second substrates 12, 14 are spaced apart from each other by a relatively large distance of about 5˜20 mm. By enlarging the distance between the substrates 12, 14, the arcing generation in the vacuum vessel 16 can be reduced. Therefore, the anode electrode 32 may be applied with a voltage of 10 kV or more, and in an exemplary embodiment, 15 kV.

The above-described light emission device 10 can realize a luminance of about 10,000 cd/m² at a central portion of the active area. That is, the light emission device 10 can realize a relatively higher luminance with relatively lower power consumption compared with a cold cathode fluorescent lamp (CCFL) type light emission device and a light emitting diode (LED) type light emission device.

In order to enhance the light emission uniformity of the active area, the light emission device 10 has the following arrangement of the electron emission regions 28.

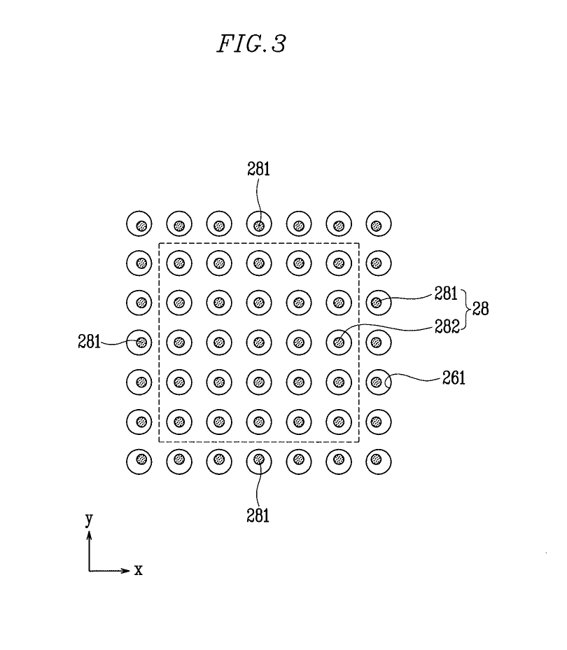

FIG. 3 is a partial top view of an arrangement of the openings and the electron emission regions that are positioned at one of the intersection regions of cathode and gate electrodes. The electron emission regions 28 and the openings 261 corresponding to the electron emission regions 28 are arranged at each of the intersection regions of the gate and cathode electrodes 26, 22 lengthwise and widthwise of the gate electrode 26.

The electron emission regions 28 are classified into first electron emission regions 281 arranged along a periphery of the intersection region and second electron emission regions 282 surrounded by the first electron emission regions 281. The first electron emission regions 281 may be arranged along one or more of the outermost lines. FIG. 3 illustrates a case where the first electron emission regions 281 are arranged along one outer line.

In the present exemplary embodiment, a center of each of the second electrode emission regions 282 is aligned with a center of the corresponding opening 261. A center of each of the first electron emission regions 281 is located apart from a center of the corresponding opening 261. That is, the first electron emission regions 281 are not centered to the corresponding openings 261.

More specifically, the center of the each of the first electron emission regions 281 is shifted away from the center of the corresponding opening 261 toward a center of the intersection region. This shift of the center of the first electron emission region 281 is for varying an electron beam path. That is, the electron beam's advancing direction is opposite to the direction in which the center of the first electron emission region 281 is spaced apart from the center of the opening 261.

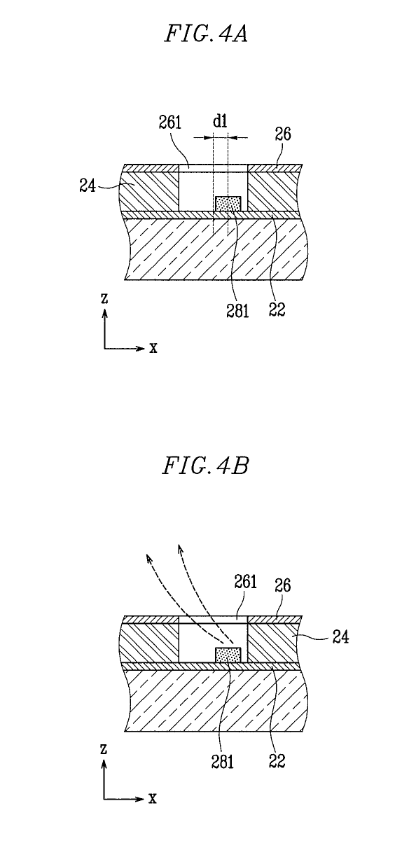

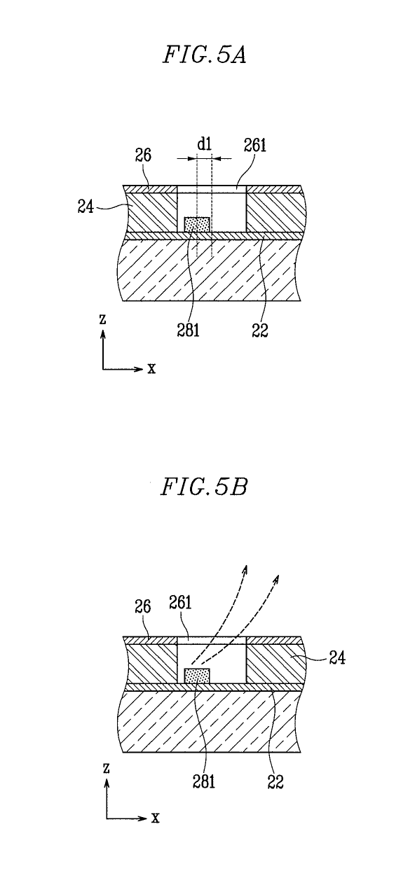

FIG. 4A and FIG. 4B are partial sectional views illustrating one of the first electron emission regions arranged in a left line with reference to FIG. 3, and FIG. 5A and FIG. 5B are partial sectional views illustrating one of first electron emission regions arranged in a right line with reference to FIG. 3.

The centers of the first electron emission regions 281 illustrated in FIGS. 4A and 4B are shifted away from the centers of the corresponding openings 261 and towards the center of the intersection region (rightward in the drawing). That is, the center of the first electron emission region 281 is spaced away from the center of the corresponding opening 261 by a distance d1. When the first electron emission region 281 is shifted rightward as described above, an asymmetric electric field is formed around the first electron emission region 281 and thus the advancing direction of the electron beam is shifted leftward in the drawing, i.e., outward from the intersection region.

The centers of the first electron emission regions 281 illustrated in FIGS. 5A and 5B are shifted away from the centers of the corresponding openings 261 and towards the center of the intersection region (leftward in the drawing). That is, the center of the first electron emission region 281 is spaced away from the center of the corresponding opening 261 by the distance d1. When the first electron emission region 281 is shifted leftward as described above, an asymmetric electric field is formed around the first electron emission region 281 and thus the advancing direction of the electron beam is shifted rightward in the drawing, i.e., outward from the intersection region.

The asymmetric distances d1 of the first electron emission regions 281 toward the center of the intersection regions are identical to each other. As a result, a more uniform electron beam diffusion can be realized along the periphery of the intersection region. In addition, the electrons emitted from the second electron emission regions 282 travel toward the second substrate 14 at a predetermined diverging angle without any specific directional property (see FIG. 2).

As described above, the light emission device 10 of this exemplary embodiment emits properly the electron beams to a corresponding portion of the phosphor layer 30 to a boundary of the intersection regions through the electron beam diffusion of the first electron emission regions 281. Therefore, the light emission device 10 of the present invention reduces a luminance difference between a corresponding portion of the phosphor layer 30 to the central portions of the intersection regions and a corresponding portion of the phosphor layer 30 to the boundary of the intersection regions, thereby improving the light emission uniformity of the active area.

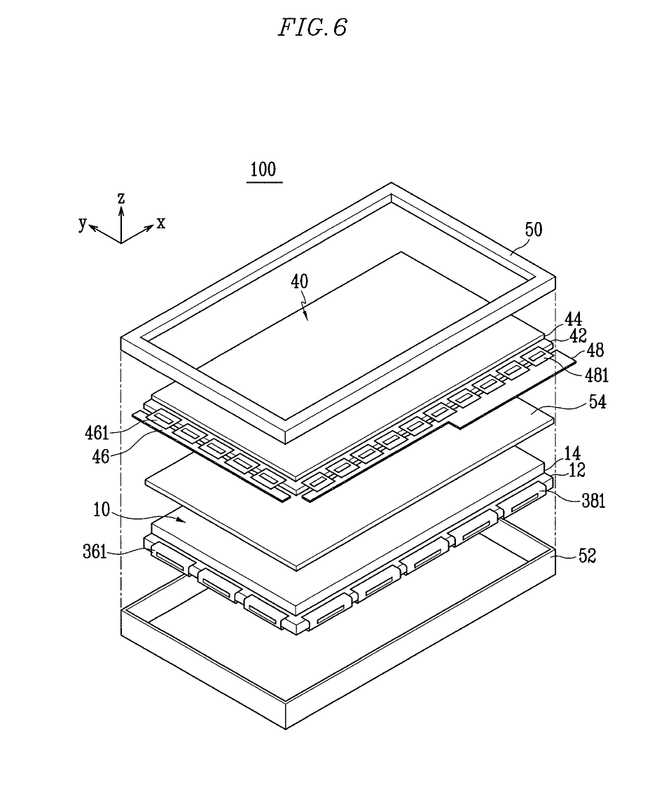

FIG. 6 is an exploded perspective view of a display device employing the light emission device of the exemplary embodiment of FIGS. 1 through 5. The display device of FIG. 6 is exemplary only, not limiting the present invention.

Referring to FIG. 6, a display device 100 of an exemplary embodiment includes a light emission device 10 and a display panel 40 disposed in front of the light emission device 10. A top chassis 50 is disposed in front of the display panel 40 and a bottom chassis 52 is disposed rear of the light emission device 10.

A diffuser 54 for uniformly diffusing the light emitted from the light emission device 10 toward the display panel 40 may be disposed between the display panel 40 and the light emission device 10. The diffuser 54 is spaced apart from the light emission device 10 by a predetermined distance. Because the light emission device 10 is designed to improve the light emission uniformity of the active area through the position shift of the first electron emission regions, a distance between the diffuser 54 and the light emission device 10 is reduced and thus the display device 100 can realize a more slim profile.

The display panel 40 may be a liquid crystal display panel or other passive-type display panels. In the following description, the liquid crystal display panel is described as an example.

The display panel 40 includes a thin film transistor (TFT) substrate 42 having a plurality of TFTs, a color filter substrate 44 disposed on the TFT substrate 42, and a liquid crystal layer (not shown) disposed between the TFT substrate 42 and the color filter substrate 44. Polarizer panels (not shown) are attached on a top surface of the color filter substrate 44 and a bottom surface of the TFT substrate 42 to polarize the light passing through the display panel 40.

A data line is connected to a source terminal of one TFT and a gate line is connected to a gate terminal of the TFT. In addition, a pixel electrode formed of a transparent conductive layer is connected to a drain terminal of the TFT. When electrical signals are inputted from circuit board assemblies 46, 48 to the respective gate and data lines, electrical signals are then inputted to the gate and source terminals of the TFT. The TFT turns on or off according to the electrical signals inputted to output an electrical signal required for driving the pixel electrode to the drain terminal.

RGB color filters are formed on the color filter substrate 44 so as to emit predetermined colors as the light passes through the color filter substrate 44. A common electrode formed of a transparent conductive layer is deposited on an entire surface of the color filter substrate 44. When electrical power is applied to the gate and source terminals of the TFTs to turn on the TFTs, an electric field is formed between the pixel electrode and the common electrode. In reaction to the electric field, the twist angle of liquid crystal molecules of the liquid crystal layer varies and thus the light transmittance of each pixel varies according to the varied twist angle of the liquid crystal molecules.

The circuit board assemblies 46, 48 of the display panel 40 are connected to drive IC packages 461, 481, respectively. In order to drive the display panel 40, the gate circuit board assembly 46 transmits a gate drive signal and the data circuit board assembly 48 transmits a data drive signal.

The number of pixels of the light emission device 10 is less than that of the display panel 40 such that one pixel of the light emission device 10 corresponds to two or more pixels of the display panel 40. Each pixel of the light emission device 10 emits light in response to the highest gray level among the corresponding pixels of the display panel 40. The light emission device 10 can represent 2˜8 bits gray level at each pixel.

For convenience, the pixels of the display panel 40 will be referred to as first pixels and the pixels of the light emission device 10 will be referred to as second pixels. In addition, a plurality of first pixels corresponding to one second pixel will be referred to as a first pixel group.

In order to drive the light emission device 10, a signal control unit (not shown) for controlling the display panel 40 detects a highest gray level among the gray levels of the first pixels of the first pixel group, calculates a gray level required for the light emission of the second pixel according to the detected highest gray level, converts the calculated gray level into digital data, and generates a driving signal of the light emission device 10 using the digital data. The drive signal of the light emission device 10 includes a scan drive signal and a data drive signal.

Circuit board assemblies (not shown), that is a scan circuit board assembly and a data circuit board assembly of the light emission device 10, are connected to drive IC packages 361, 381, respectively. In order to drive the light emission device 10, the scan circuit board assembly transmits a scan drive signal and the data circuit board assembly transmits a data drive signal. One of the cathode and gate electrodes receives the scan drive signal and the other receives the data drive signal.

Therefore, when an image is displayed by the first pixel group, the corresponding second pixel of the light emission device 10 is synchronized with the first pixel group to emit the light with a predetermined gray level. As described above, in the light emission device 10, the light emission intensities of the pixels of the light emission device 10 are independently controlled to emit a proper intensity of the light to each first pixel group of the display panel 40.

Therefore, the display device 100 of the present exemplary embodiment can enhance the dynamic contrast of the screen, thereby improving the display quality.

Although exemplary embodiments of the present invention have been shown and described, it will be appreciated by those skilled in the art that changes may be made in the exemplary embodiments without departing from the principles and spirit of the invention, the scope of which is defined in the claims and their equivalents.

What is claimed is:

1. A light emission device comprising:
a first substrate having a first substrate surface and a second substrate having a second substrate surface, the first substrate facing the second substrate;
cathode electrodes arranged on the first substrate surface;
gate electrodes arranged crossing over the cathode electrodes to form crossing regions, the gate electrodes having a plurality of openings in the crossing regions, the plurality of openings each having a center;
electron emission regions formed on the cathode electrodes in the plurality of openings; and
a light emission unit provided on the second substrate surface,
wherein at least one of the electron emission regions is positioned off of the center of a corresponding one of the plurality of openings.

2. The light emission device of claim 1, wherein the electron emission regions include first electron emission regions arranged along a periphery of respective crossing regions and second electron emission regions surrounded by the first electron emission regions, and
wherein each of the first electron emission regions is located off of the center of a corresponding one of the plurality of openings.

3. The light emission device of claim 2, wherein each of the first electron emission regions is located toward a center of a respective crossing region.

4. The light emission device of claim 2, wherein each of the second electron emission regions is located in the center of a corresponding one of the plurality of openings.

5. The light emission device of claim 3, wherein distances of each of the first electron emission regions from the center of a corresponding one of the plurality of openings are substantially equal to each other.

6. The light emission device of claim 1, wherein the light emission unit includes:
a phosphor layer provided on the second substrate surface; and
an anode electrode formed on a surface of the phosphor layer.

7. The light emission device of claim 6, wherein a distance between the first substrate and the second substrate is in a range of 5 mm-20 mm; and
the anode electrode is applied with an anode voltage in the range of 10 kV-15 kV.

8. A display device comprising:
a display panel for displaying an image; and
a light emission device for emitting light toward the display panel,
wherein the light emission device includes:
a first substrate having a first substrate surface and a second substrate having a second substrate surface, the first substrate facing the second substrate;
cathode electrodes arranged on the first substrate surface;
gate electrodes arranged crossing over the cathode electrodes to form crossing regions, the gate electrodes having a plurality of openings in the crossing regions, the plurality of openings each having a center;
electron emission regions formed on the cathode electrodes in the plurality of openings; and
a light emission unit provided on the second substrate surface,
wherein at least one of the electron emission regions is located off of the center of a corresponding one of the plurality of openings.

9. The display device of claim 8, wherein the electron emission regions include first electron emission regions arranged along a periphery of respective crossing regions and second electron emission regions surrounded by the first electron emission regions, and
wherein each of the first electron emission regions is located off of the center of a corresponding one of the plurality of openings.

10. The display device of claim 9, wherein each of the first electron emission regions is located towards a center of a respective crossing region and each of the second electron emission regions is located in the center of a corresponding one of the plurality of openings.

11. The display device of claim 10, wherein distances of each of the first electron emission regions from the center of a corresponding one of the plurality of openings are substantially equal to each other.

12. The display device of claim 8, wherein the light emission unit includes:
a phosphor layer provided on the second substrate surface; and
an anode electrode formed on a surface of the phosphor layer.

13. The display device of claim 8, wherein
the display panel includes first pixels and the light emission device includes second pixels, a number of second pixels being less than a number of first pixels, and
light emission intensities of the second pixels are independently controlled.

14. The display device of claim 8, wherein the display panel is a liquid crystal panel.

15. A method of improving electron beam diffusion uniformity along a periphery of a crossing region of gate electrodes and cathode electrodes, the gate electrodes having openings in said crossing region, the openings each having a center, the method comprising:
forming electron emission regions in the openings on the cathode electrodes; and
locating at least one of the electron emission regions off of the center of corresponding openings.

16. The method as claimed in claim 15, wherein the openings include periphery openings located along a periphery of said crossing region and non-periphery openings located within the periphery of said crossing region, the method further comprising:
locating the electron emission regions formed in periphery openings off of the center of corresponding periphery openings.

17. The method as claimed in claim 16, the method further comprising:
locating the electron emission regions formed in periphery openings towards a center of said crossing region.

18. The method as claimed in claim 17, the method further comprising:
locating each of the electron emission regions formed in periphery openings a substantially equal distance from the center of corresponding periphery openings.

19. The method as claimed in claim 18, the method further comprising:
locating the electron emission regions formed in non-periphery openings at the center of corresponding non-periphery openings.

20. The method as claimed in claim 19, wherein periphery openings include side periphery openings and corner periphery openings, the method further comprising:
locating each of the electron emission regions formed in side periphery openings a substantially equal distance from adjacent electron emission regions formed in non-periphery openings; and
locating each of the electron emission regions formed in corner periphery openings a substantially equal distance from adjacent electron emission regions formed in non-periphery openings.
